(19) United States
(12) Patent Application Publication
(10) Pub. No.: US 2022/0084306 A1
(43) Pub. Date: Mar. 17, 2022

(54) METHOD AND SYSTEM OF GUIDING A USER ON A GRAPHICAL INTERFACE WITH COMPUTER VISION

(71) Applicants: KALPIT JAIN, MOUNTAIN VIEW, CA (US); RUTURAJ WAGHMODE, MOUNTAIN VIEW, CA (US); BADRINATH MUTKULE, MOUNTAIN VIEW, CA (US)

(72) Inventors: KALPIT JAIN, MOUNTAIN VIEW, CA (US); RUTURAJ WAGHMODE, MOUNTAIN VIEW, CA (US); BADRINATH MUTKULE, MOUNTAIN VIEW, CA (US)

(21) Appl. No.: 17/364,497

(22) Filed: Jun. 30, 2021

Related U.S. Application Data
(60) Provisional application No. 63/051,384, filed on Jul. 14, 2020.

(51) Int. Cl. G06V 10/75; G06V 10/56

(52) U.S. Cl. CPC G06V 10/751; G06V 10/56; G06V 10/759

(57) ABSTRACT

A computerized method useful for guiding a user on a graphical interface with computer vision includes the step of providing an ability to use computer vision to observe an area of user touch interest at a create time. The method includes the step of providing an ability to location the area at a play back time. The method includes the step of linking a user input click with real step-by-step guide via the graphical interface. The method includes the step of automating a mobile workflow with a computer vision functionality and a robotic touch arm.

### CLAIM OF PRIORITY

This application claims priority to U.S. Provisional Patent Application No. 63/051,384 filed on 14 Jul. 2020 and titled METHOD AND SYSTEM OF GUIDING A USER ON A GRAPHICAL INTERFACE WITH COMPUTER VISION. This application is incorporated by reference in its entirety.

### BACKGROUND

There is a need to enable any human computer task to be automated simply by observing human workflow via a set of images and deriving the workflow based on images and human inputs. There is a need to enable any human computer task to be automated simply by observing human workflow via a set of images and deriving the workflow based on images and human inputs. Accordingly, improvements to the ability to guide a user on a graphical interface with computer vision are desired.

### SUMMARY OF THE INVENTION

A computerized method useful for guiding a user on a graphical interface with computer vision includes the step of providing an ability to use computer vision to observe an area of user touch interest at a create time. The method includes the step of providing an ability to location the area at a play back time. The method includes the step of linking a user input click with real step-by-step guide via the graphical interface. The method includes the step of automating a mobile workflow with a computer vision functionality and a robotic touch arm.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for converting unstructured insurance document to a structured output, according to some embodiments.

FIG. 2 depicts an exemplary computing system that can be configured to perform any one of the processes provided herein.

The Figures described above are a representative set, and are not an exhaustive with respect to embodying the invention.

### DESCRIPTION

Disclosed are a system, method, and article of manufacture for guiding a user on a graphical interface with computer vision. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Application programming interface (API) is a computing interface which defines interactions between multiple software intermediaries.

Artificial intelligence (AI) is intelligence demonstrated by machines.

Computer vision is an interdisciplinary scientific field that deals with how computers can gain high-level understanding from digital images or videos.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Natural language processing (NLP) is a subfield AI that with the interactions between computers and human (natural) languages and concerns programing computers to process and analyze large amounts of natural language data. NLP can utilize speech recognition, natural language understanding, natural language generation, etc.

Optical character recognition or optical character reader (OCR) is the electronic or mechanical conversion of images of typed, handwritten, or printed text into machine-encoded text, whether from a scanned document, a photo of a document, a scene-photo.

Portable Document Format (PDF) is a file format to present documents, including text formatting and images, in a manner independent of application software, hardware, and operating systems.

Scale-invariant feature transform (SIFT) is a feature detection algorithm in computer vision to detect and describe local features in images.

Speeded up robust features (SURF) is a patented local feature detector and descriptor. It can be used for tasks such as object recognition, image registration, classification, or 3D reconstruction.

Exemplary Methods

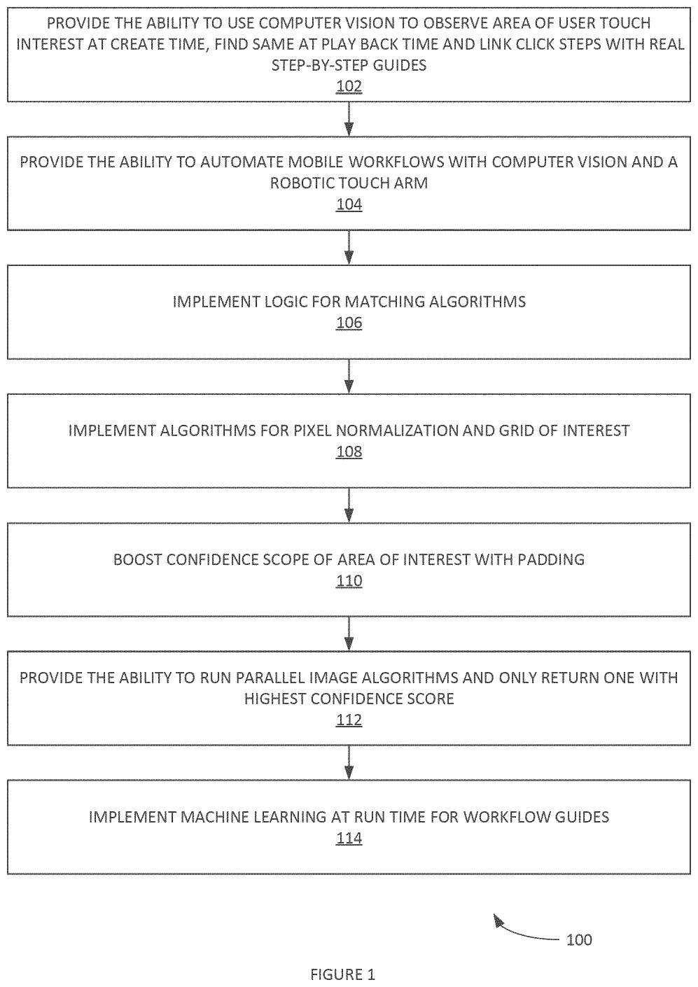

FIG. 1 illustrates an example process 100 for guiding a user on a graphical interface with computer vision, according to some embodiments. In step 102 process 100 can provide the ability to use computer vision to observe area of user touch interest at create time, find same at play back time and link click steps with real step-by-step guides. In step 104, process 100 can provide the ability to automate mobile workflows with computer vision and a robotic touch arm.

In step 106, process 100 can implement logic for matching algorithms. A master matching algorithm can be implemented to determine which algorithm to use for a given step (e.g. template matching, feature matching, color matching, etc.).

In step 108, process 100 can implement algorithms for pixel normalization and grid of interest. For example, process can implement computer vision for one rectangle in a 9×9 grid or one rectangle in a single 255 by 255 grid, etc. In one example, the grid can scale from 9 by 9 to 255 by 255.

In step 110, process can boost confidence scope of area of interest with padding. In step 112, process 100 can provide the ability to run parallel image algorithms and only return one with highest confidence score.

In step 114, process 100 can implement machine learning at run time for workflow guides. Subject matter experts can be used to teach and/or train the machine learning algorithm(s). This can be used to form a feedback loop.

Example Systems

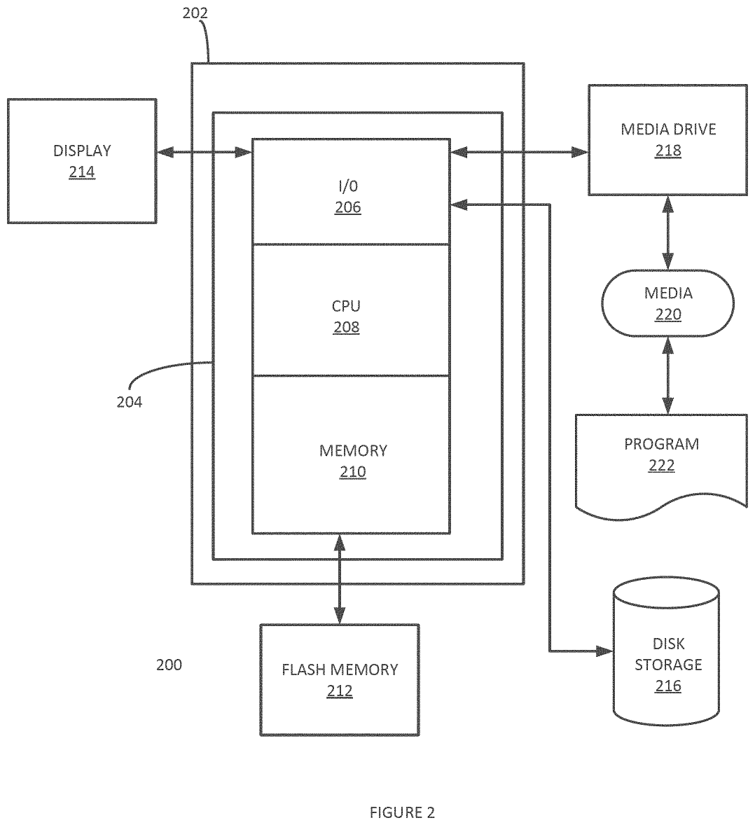

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Machine Learning Processes

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

Additional Screenshots

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computerized method useful for guiding a user on a graphical interface with computer vision comprising:
providing an ability to use computer vision to observe an area of user touch interest at a create time;
providing an ability to location the area at a play back time;
linking a user input click with real step-by-step guide via the graphical interface; and
automating a mobile workflow with a computer vision functionality and a robotic touch arm.

2. The computerized method of claim 1 further comprising:
implementing at least one matching algorithm.

3. The computerized method of claim 2, wherein the matching algorithm determine which algorithm to use for a given step.

4. The computerized method of claim 3, wherein the matching algorithm comprises a template matching algorithm, feature matching algorithm, and a color matching algorithm.

5. The computerized method of claim 2 further comprising:
implementing a pixel normalization algorithms.

6. The computerized method of claim 5 further comprising:
determining a grid of interest.

7. The computerized method of claim 6, wherein the computer vision algorithm is implemented for one rectangle in a nine by nine (9λ9) grid of interest.

8. The computerized method of claim 6, wherein the computer vision algorithm is implemented for one rectangle in a single two hundred and fifty-five by two hundred and fifty-five (255×255) grid of interest.

9. The computerized method of claim 6, wherein the grid of interest scales from 9×9 to 255×255.

10. The computerized method of claim 6 further comprising:
boosting a confidence scope of area of interest with a specified padding.

11. The computerized method of claim 10 further comprising:
providing the ability to run a parallel image algorithm and only returning an image result with a highest confidence score.

12. The computerized method of claim 10 further comprising:
Implementing a specified machine learning algorithm at run time for optimizing a workflow guide.

13. The computerized method of claim 12, wherein a subject matter expert is used to teach and train the specified machine learning algorithm to form a feedback loop.
